(19) United States
(12) Patent Application Publication
(10) Pub. No.: US 2011/0089265 A1
(43) Pub. Date: Apr. 21, 2011

(54) HOSE COUPLING SYSTEM

(75) Inventors: Richard J. Gilpatrick, Whitewater, WI (US); Steven C. Crouch, McFarland, WI (US)

(73) Assignee: Briggs & Stratton Corporation

(21) Appl. No.: 12/582,493

(22) Filed: Oct. 20, 2009

(51) Int. Cl. B05B 9/01; F16L 37/28

(52) U.S. Cl. 239/526; 251/149.9

(57) ABSTRACT

A hose coupling system includes a housing, a valve plug, and a locking mechanism. The housing has an inlet and an outlet, and a flow path between the inlet and the outlet. The valve plug is positioned within the housing along the flow path, and is rotatable between a closed orientation and an opened orientation. The closed orientation blocks the flow path and the opened orientation unblocks the flow path. The locking mechanism is designed to releasably fasten an instrument to the housing, where the locking mechanism is adjustable between a locked position and an unlocked position. The locking mechanism and the valve plug are coupled such that adjusting the locking mechanism to the unlocked position rotates the valve plug to the closed orientation.

### BACKGROUND

The present invention relates generally to the field of hose couplings. More specifically, the present invention relates to a sprayer and hose coupling system for use with a garden hose.

A booster pump system enhances a household garden hose, generating an increased pressure and flow rate suitable for otherwise difficult cleaning and gardening applications. For example, a water stream generated by a booster pump system may be useful for removing stuck-on plant debris from a vehicle, removing dried-on bird waste from a window, or removing spider webs from an eve of a high roof line, out of reach of a garden hose having unassisted pressure and flow.

A user of a booster pump system may desire an increased flow rate and pressure beyond the capabilities of an unassisted garden hose, but not with the reduced flow rate and much higher pressures typical of a pressure washer. For example, without boosting, an unassisted garden hose using municipal or well water is limited to water from a faucet or bibcock, typically supplied at a pressure of about 40-60 pounds per square inch (psi), flowing at a rate of about 3-5 gallons per minute (gpm). Conversely, pressure washers generally provide a water stream with a much higher pressure, such as 1400 psi, but with a lower flow rate, such as 1.3-1.4 gpm. Booster pumps are designed to raise the pressure of faucet water to a lesser degree than pressure washers (e.g., by 100 psi), and to raise the flow rate by an amount on the order of 2 gpm. Unlike pressure washers, booster pumps are designed to generate water pressures and flow rates compatible with conventional garden hoses.

Garden hoses may be made from a wide variety of commonly known materials such as vinyl, rubber, composite, synthetic rubber, soft plastic, etc. “Reinforced vinyl” garden hoses are reinforced with internal or external fiber webbings, such as nylon or polyester tire-cords. Due to the variety of design choices and available materials, different commercial garden hoses have different “burst strengths” or “burst ratings,” which are the maximum allowable internal pressures that a hose can withstand before rupture. Some lesser-strength garden hoses have a burst rating of about 200 psi. Other medium-strength garden hoses have burst ratings ranging from about 275 to 350 psi. Still other higher-strength garden hoses have burst ratings from about 350 to 500 psi or higher.

In the United States, standard hose couplings are attached to the ends of a garden hose, such as a male or female threaded fittings, quick connect fittings, etc. Unlike threaded fittings, quick connect fittings allow garden hoses to be coupled without first turning the water off at the faucet. A valve in the female quick connect fitting blocks the water flow when the male fitting is not engaged. The valve also produces a trapped pressure in the hose. To connect or disconnect the fittings, a user must overcome the trapped pressure, such as by manually pulling or pushing back a sleeve coupled to the valve. In the process, the user may get sprayed by a small burst of trapped water that is released when the valve is temporarily opened. Overcoming the trapped pressure to release or engage the coupling is increasingly difficult as trapped water pressure in the garden hose is increased, as may occur with use of a booster pump system.

### SUMMARY

One embodiment of the invention relates to a hose coupling system that includes a housing, a valve plug, and a locking mechanism. The housing has an inlet and an outlet, and a flow path between the inlet and the outlet. The valve plug is positioned within the housing along the flow path, and is rotatable between a closed orientation and an opened orientation. The closed orientation blocks the flow path and the opened orientation unblocks the flow path. The locking mechanism is designed to releasably fasten an instrument to the housing, where the locking mechanism is adjustable between a locked position and an unlocked position. The locking mechanism and the valve plug are coupled such that adjusting the locking mechanism to the unlocked position rotates the valve plug to the closed orientation.

Another embodiment of the invention relates to a hose coupling system that includes a housing, a valve plug, and a locking mechanism. The housing has an inlet and an outlet, and a flow path between the inlet and the outlet. The inlet includes a garden hose connector. The valve plug is positioned within the housing along the flow path, and is rotatable between a closed configuration blocking the flow path and an opened configuration unblocking the flow path. The locking mechanism releasably fastens a sprayer to the housing, where the locking mechanism is rotatable between a locked position fastening the sprayer to the housing and an unlocked position releasing the sprayer. Rotation of the locking mechanism rotates the valve plug.

Yet another embodiment of the invention relates to a sprayer system for a booster pump for a garden hose. The sprayer system includes a water sprayer, a housing, a locking mechanism, and a valve. The water sprayer has an inlet, an outlet, a handle, and a trigger. The housing has a garden hose connector and a port for the inlet of the water sprayer. The locking mechanism is adjustable between a locked position, fastening the inlet to the housing, and an unlocked position, releasing the inlet from the housing. The valve includes a valve plug positioned within the housing and rotatable between a closed configuration, which blocks water from flowing through the valve, and an opened configuration, which allows water to flow through the valve. Adjustment of the locking mechanism rotates the valve plug.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a booster pump system for a garden hose according to an exemplary embodiment of the invention.

FIG. 2 is a schematic view of the booster pump system of FIG. 1.

FIG. 3 is a perspective view of a sprayer connected to a hose coupling according to an exemplary embodiment of the invention.

FIG. 4 is a cut-away perspective view of the sprayer and hose coupling of FIG. 3.

FIG. 5 is an exploded view of a hose coupling according to another exemplary embodiment of the invention.

FIG. 6 is a side elevation view of a hose coupling according to yet another exemplary embodiment of the invention.

FIG. 7 is a front elevation view of the hose coupling of FIG. 6.

FIG. 8 is a sectional view of a hose coupling according to still another embodiment of the invention.

FIG. 9 is a sectional view of the hose coupling of FIG. 8.

FIG. 10 is a sectional view of a locking mechanism according to an exemplary embodiment of the invention.

FIG. 11 is a sectional view of a locking mechanism according to another exemplary embodiment of the invention.

### DETAILED DESCRIPTION OF THE EXEMPLARY EMBODIMENTS

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

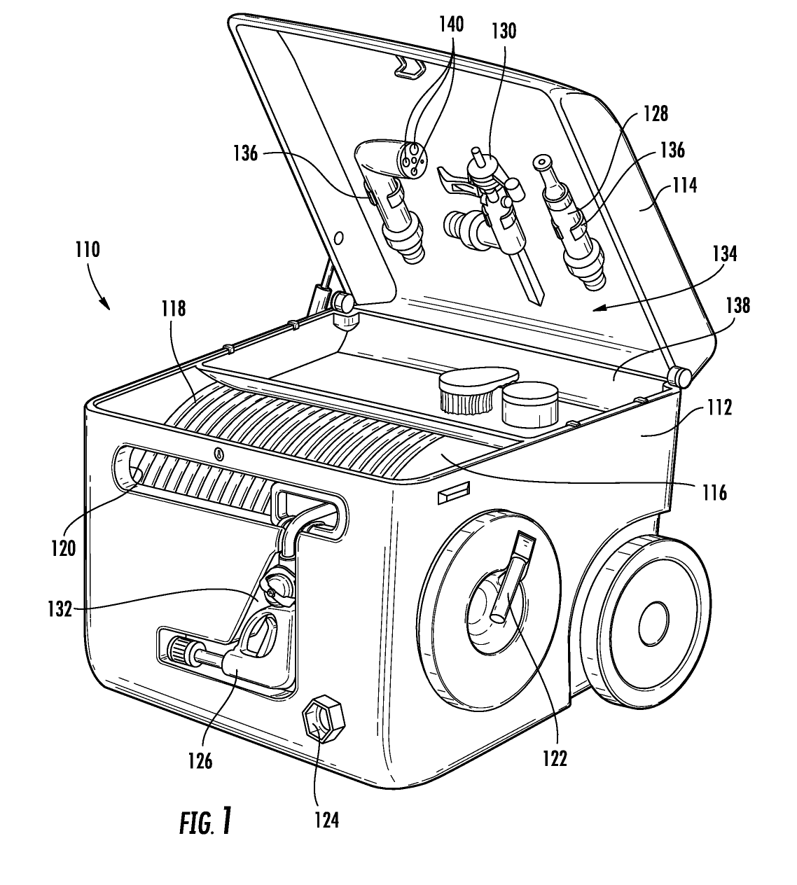

Referring to FIG. 1, a booster pump system 110 includes a housing 112 having a cover 114. Within the housing 112, the booster pump system 110 includes a hose reel 116 designed to support a garden hose 118. According to an exemplary embodiment, the housing 112 and the hose reel 116 are sized such that a 100-foot hose may be wound on the hose reel 116. An aperture 120 in the housing 112 provides an opening through which the garden hose 118 may be extracted. A rewind handle 122 may be coupled to housing 112 and used to manually wind the hose reel 116. An inlet fitting 124 for the booster pump system 110 is formed in the housing 112 and allows for a second garden hose to link the booster pump system 110 to a water source. The inlet fitting 124 is shown as a female quick connect fitting.

The garden hose 118 may be fitted with a sprayer, such as a spray gun 126, a nozzle 128, a sprinkler 130, or other sprayer. The spray gun 126 may be stored in a cavity 132 on the housing 112, or in a storage area 134 within the housing 112. The cavity 132 or the storage area 134 may include mounting clips 136 and a removable tray 138. In some embodiments, the spray gun 126 may include calibrated spray settings 140 having different cross-sectional areas to allow for different exit stream flow rates.

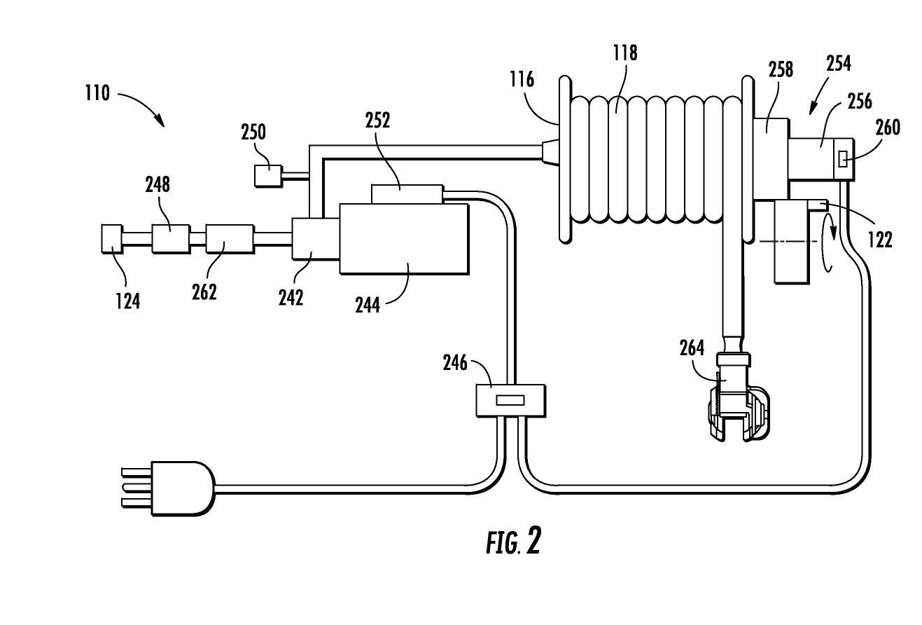

Referring to FIG. 2, a power rewind system 254 may augment or take the place of the rewind handle 122 of the booster pump system 110. The power rewind system 254 includes a motor 256, a transmission 258, and a power switch 260. Activation of the power rewind system 254 both winds and lays the hose 118 on the hose reel 116 in an ordered manner. The power rewind system 254 may be activated by a user pressing a foot pedal (not shown) on an exterior of the housing 112, positioned near the base of the housing 112. On an end of the hose 118, a hose coupler 264 may be used to attach a water sprayer, such as the spray gun 126, the nozzle 128, or the sprinkler 130.

Still referring to FIG. 2, additional components related to the booster pump system 110 include a water pump 242 (e.g., centrifugal water pump), a motor 244, and an electric power switch 246. The water pump 242 may pull water into the booster pump system 110 past a check valve 262 at a higher flow rate than that of an unassisted garden hose. In some embodiments, pressure and flow rate sensors 248, 250, placed along the flow path, provide feedback to a controller 252, which may activate or deactivate the motor 244 based upon the feedback. In other embodiments, an internal combustion engine is used to drive the water pump 242, and the booster pump system 110 may use another form of water pump, such as an axial cam pump.

According to an exemplary embodiment, the controller 252 utilizes a flow-sensitive switch that measures, detects, or monitors characteristics of water flow (e.g., flow rate) into the water pump 242, with or without using the sensors 248, 250. When the flow rate exceeds the threshold flow rate, the flow-sensitive switch is closed (i.e., “on”), and when flow rate is below the threshold flow rate the flow-sensitive switch is open (i.e., “off”). Opening the flow-sensitive switch cuts power to and disengages the water pump 242. In some embodiments, sensed pressures may provide control feedback. In other embodiments, the controller includes a flow sensor coupled to a clutch to engage or disengage a power take off from an internal combustion engine. In still other embodiments, the controller may be a manual on/off switch.

In some embodiments, the threshold rate corresponds to calibrated spray settings 140 on the sprayer, where a first setting generates a water flow rate that is above the threshold flow rate, closing the flow-sensitive switch and activating the water pump 242. A second setting reduces the water flow rate below the threshold flow rate, opening the flow-sensitive switch and deactivating the water pump 242. Exemplary threshold flow rate values range from 1-5 gpm, preferably from 2.5-3.5 gpm. According to other embodiments, different commercially available gauges, sensors, meters, etc. may be provided to sense characteristics of the water flow and provide feedback to the controller 252.

According to an exemplary embodiment, the booster pump system 110 may have a maximum pressure capacity (e.g., maximum setting) of less than 1000 psi, preferably less than 500 psi; and a water flow rate capacity of at least 4 gpm, preferably at least 5 gpm. In another embodiment, the booster pump system 110 is designed to raise water pressure by 20-200 psi, preferably between 50-100 psi; and to raise water flow rate by 0.5-5 gpm, preferably between 1-3 gpm. In at least one embodiment, the booster pump system 110 is designed to raise water pressure by about 80 psi and raise flow rate by about 2 gpm from the unassisted pressure and rate.

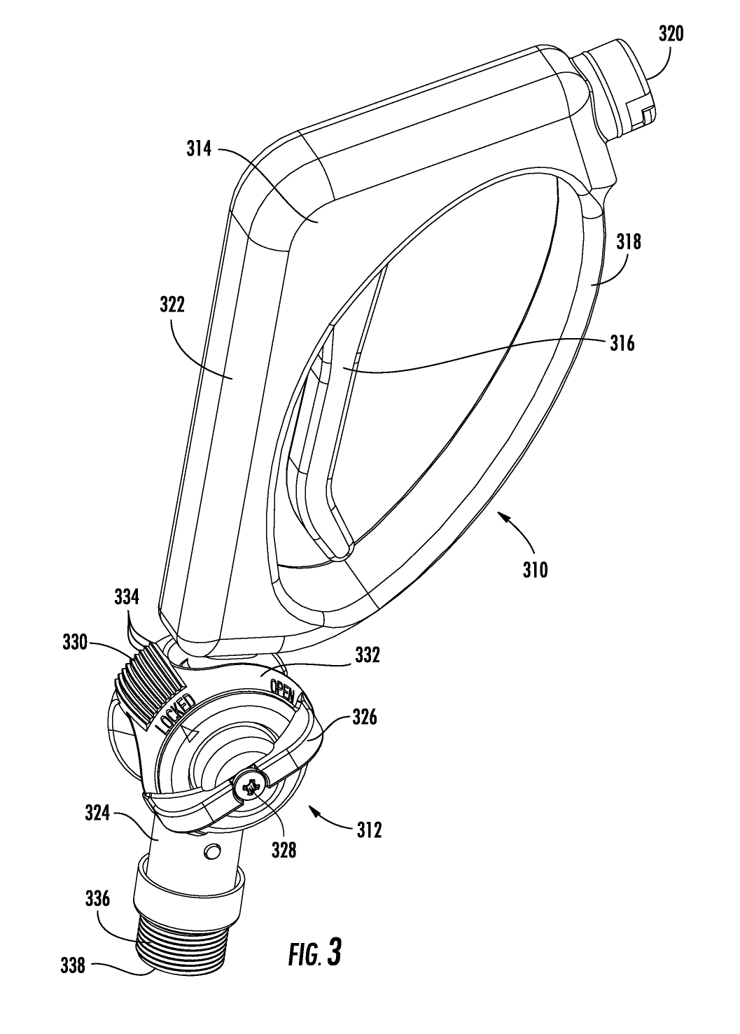

Referring now to FIGS. 3-4, a sprayer system includes a spray gun 310 attached to a coupler 312. The spray gun 310 and the coupler 312 may be used in conjunction with the garden hose 118 and the booster pump system 110 as shown in FIG. 1. The spray gun 310 includes a housing 314, a trigger 316, a trigger guard 318 surrounding the trigger 316, an inlet 410 (see FIG. 4), and an outlet 320. The housing 314 of the spray gun 310 additionally contains internal components (not shown), including a flow-control valve and plumbing that forms a flow path connecting the inlet 410 to the outlet 320. A handle 322 of the spray gun 310 allows a user to simultaneously hold the spray gun 310 and squeeze the trigger 316, releasing the flow-control valve and employing the spray gun 310 with only one hand. In some embodiments, an extension shaft (not shown) may be coupled to the outlet 320 of the spray gun 310. In other embodiments, a nozzle (not shown) may be coupled to the outlet 320, or to the extension shaft coupled to the outlet 320.

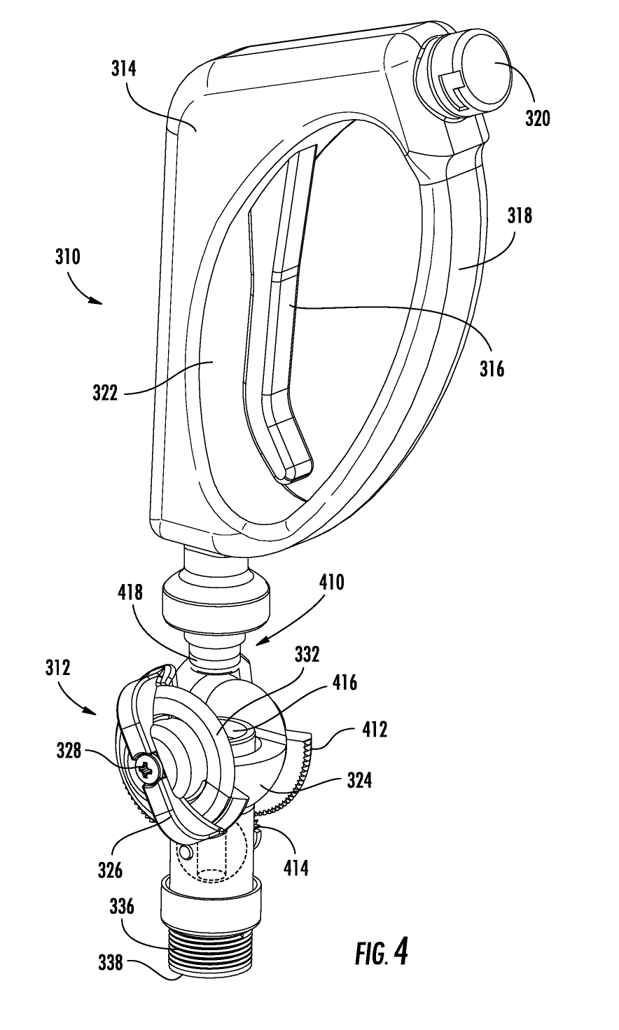

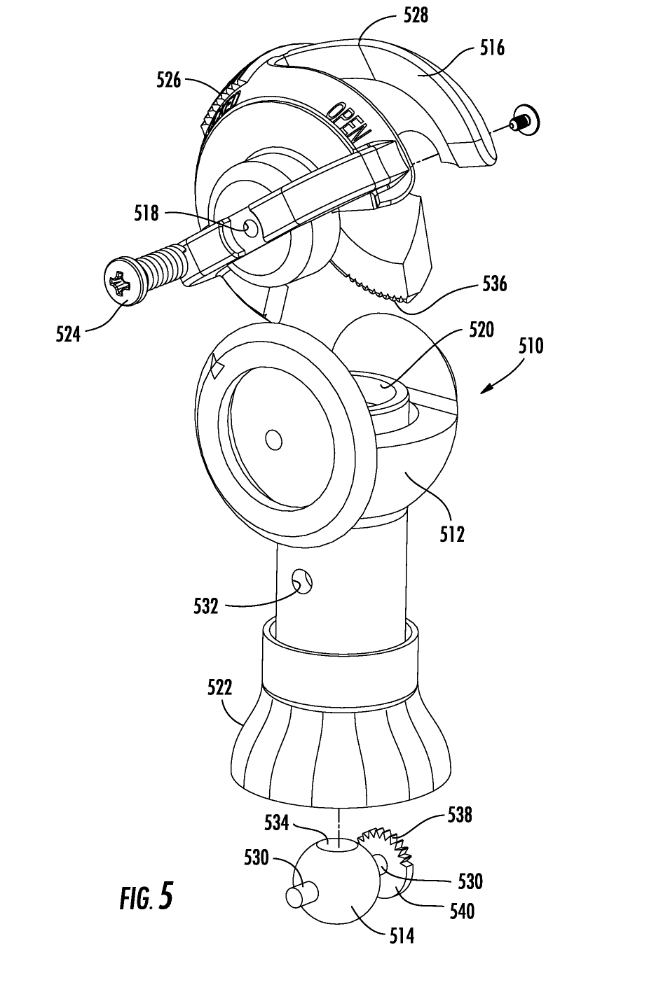

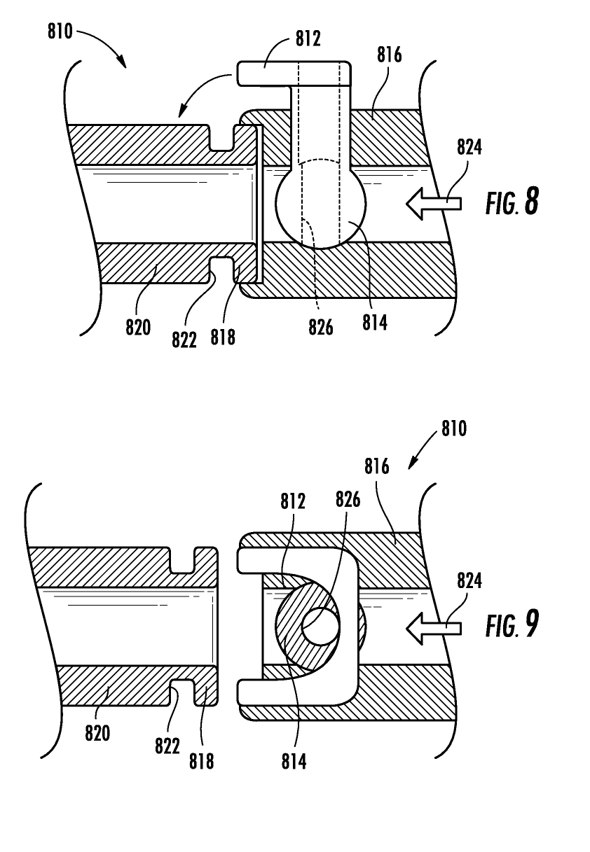

Still referring to FIGS. 3-4 the coupler 312 includes a housing 324 and a swiveling top 326 that rotates about a central pivot 328, shown as a bolt. The swiveling top 326 includes a locking mechanism (see, e.g., crow's foot 812 as shown in FIGS. 8-9) that is designed to fasten to the inlet 410 of the spray gun 310. A control switch 330 (see FIG. 3) and gear teeth 412 (see FIG. 4) are positioned on an outer perimeter 332 of the swiveling top 326. The control switch 330 includes ridges 334 to improve traction for gripping the control switch 330, and the control switch 330 may be used as a lifting point from which a user may rotate the swiveling top 326. The user may operate the control switch 330 by sliding the control switch 330 up or down, such as with a thumb of a hand that is simultaneously holding the coupler 312. The gear teeth 412 (e.g., a first gear) on the outer perimeter 332 of the swiveling top 326 are designed to mesh with a gear 414 (e.g., a second gear) coupled to a valve plug (see, e.g., valve plug 514 as shown in FIG. 5). On an inlet 338 of the housing 324, the coupler 312 further includes a garden hose connector, such as a threaded male hose connector 336.

To fasten the spray gun 310 to the coupler 312, the control switch 330 on the swiveling top 326 of the coupler 312 may be rotated to the unlocked position, pulling back a locking mechanism to a first position (see, e.g., crow's foot 812 as shown in FIGS. 8-9) and opening a port 416 within the swiveling top 326. The inlet 410 of the spray gun 310 may then be inserted into the port 416, and the user may reversibly rotate the control switch 330 to engage the locking mechanism (e.g., a second position). To unfasten the spray gun 310 from the coupler 312, the fastening process may be reversed. The user rotates the control switch 330 to the unlocked position and pulls the inlet 410 of the spray gun 310 out of the port 416. According to an exemplary embodiment, the user can operate the control switch 330 and hold the coupler 312 with one hand, while guiding the spray gun 310 into or out of the port 416 with the other hand.

Referring to FIG. 5, a coupler 510 includes a housing 512, a valve plug 514, and a swiveling top 516 coupled to a locking mechanism. An outlet port 520 of the coupler 510 is formed on a first side of the housing 512, and a female hose connector 522 is formed on a second side of the housing 512. A flow path extends through the housing 512, from the female hose connector 522 to the outlet port 520. The female hose connector 522 may be fastened to a garden hose that is connected directly to a bibcock or faucet, another hose, a booster pump system (see, e.g., garden hose 118 and booster pump system 110 as shown in FIG. 1), or the like.

The swiveling top 516 is attached to the housing 512 and is coupled to a locking mechanism. The swiveling top 516 swivels on a pivot 524, shown as a threaded screw that passes through an aperture 518 in the side of the swiveling top 516. In some embodiments, the locking mechanism includes a crow's foot latch (see, e.g., crow's foot 812 as shown in FIG. 8) that is sized to slide over a flange 418 on the inlet 410 of the spray gun 310 (see FIG. 4). The user may lock or release the locking mechanism by maneuvering a control switch 526 positioned on a periphery 528 of the swiveling top 516. Maneuvering the control switch 526 rotates the swiveling top 516, which in turn rotates the crow's foot to engage or disengage the flange 418. Additionally, the swiveling top 516 also provides a rotational joint for a garden hose accessory, such as a sprayer.

The valve plug 514 of the coupler 510 has a spherical body (e.g., ball valve) and rotates about pivots, shown as pegs 530 extending from the body. The pegs 530 are supported by bushings 532 in the housing 512 of the coupler 510. In other embodiments, different types of bearings are used. An aperture 534 extends through the valve plug 514. The valve plug 514 may be rotated such that the aperture 534 intersects or does not intersect a flow path, extending within the housing 512 between the female hose connector 522 and the outlet port 520. The valve plug 514 is in an opened configuration when valve plug 514 is rotated so that the aperture 534 intersects the flow path, such as when the aperture 534 is fully aligned with the flow path. The valve plug 514 is in a closed configuration when the valve plug 514 is rotated so that the aperture 534 does not intersect the flow path, and the body of the valve plug 514 blocks the flow path. In other embodiments, the valve plug does not include an aperture through the valve plug, but instead has a cut in a side of the valve plug. The valve plug may be rotated so that the cut either intersects or does not intersect the flow path. For example, in one embodiment, the valve plug is C-shaped, and in another embodiment, the valve plug has cuts on two opposite sides of the body such that the flow path may pass around the two sides when the valve plug is in the opened configuration.

Still referring to FIG. 5, the periphery 528 of the swiveling top 516 includes gear teeth 536. The gear teeth 536 are positioned and sized to engage a second set of gear teeth 538 extending from a gear 540 attached to one of the pegs 530 of the valve plug 514. Through the gearing 536, 538, rotational movement of the swiveling top 516 is transferred to rotate the valve plug 514. Accordingly, rotation of the swiveling top 516 simultaneously engages the locking mechanism and adjusts the valve plug 514. Adjustment of the locking mechanism to an unlocked position rotates the valve plug 514 to the closed configuration, while adjustment of the locking mechanism to the locked position rotates the valve plug 514 to the opened configuration. In other embodiments, the swiveling top 516 and valve plug 514 are coupled by a hinged bar, a pulley, other types of gears, or other commercially-available linkages to transfer motion between the swiveling top 516 and the valve plug 514.

In some embodiments, the gearing 536, 538 is arranged to provide a delay or offset between locking of the locking mechanism and opening of the valve plug. For example, the locking mechanism may travel at least 50%, 75%, or 90% of the rotation from the unlocked to locked positions before the valve plug is rotated. According to another embodiment, the gearing 536, 538 is arranged to provide a delay between closing of the valve plug and the unlocking of the locking mechanism. For example, the valve plug may travel at least 50%, 75%, or 90% of the rotation from the opened configuration to the closed configuration before the locking mechanism is rotated. In other embodiments, the degree of rotation of the locking mechanism between the locked and unlocked position is greater or less than the degree of rotation between the valve plug in the opened and closed configurations, such as by a ratio of about 2:1, 1.5:1, 1:1.5, or 1:2. In some embodiments, the gearing 536, 538 may be disengaged such that rotation of the locking mechanism does not simultaneously rotate the valve plug, or visa versa. For example, in at least one embodiment, the user may press a button or detent to connect the gearing 536, 538.

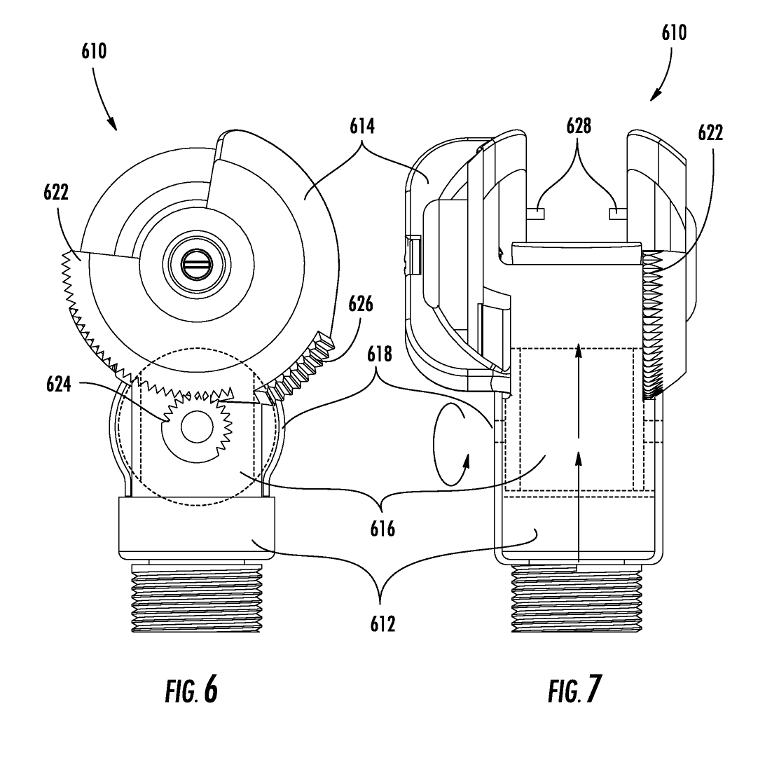

Referring to FIGS. 6-7, according to another embodiment, a coupler 610 includes a housing 612, a swivel top 614, and a valve plug 616 having a cylindrical geometry (e.g., plug valve). Like the valve plug 514 with the spherical body shown in FIG. 5, the valve plug 616 has a circular cross-section that is in line with the flow path, such that the valve plug 616 may be easily rotated relative to a pressurized body of water. The valve plug 616 may be positioned within the housing 612, with ends of the valve plug 616 rotatable in a bushing 618 formed in the housing 612. Installation of the valve plug 616 during manufacturing of the coupler 610 may include inserting the valve plug 616 through an opening in a wall of the housing 612, such as on an end of the bushing 618, and fastening a cap 620 to lock the valve plug 616 in place and seal the housing 612. According to an exemplary embodiment, the valve plug 616 is coupled to the swivel top 614 via gearing 622, 624, where adjustment of a control switch 626 on the swivel top 614 both rotates a crow's foot 628 and the valve plug 616. In other embodiments, a valve plug has another cross-sectional geometry, such as polygonal, oval, conical, tapering cylindrical, or other shapes.

Referring to FIGS. 8-9, a coupler 810 includes a locking mechanism coupled to a valve plug in a first body, and a second body with a receiving portion for the locking mechanism to engage. As shown, the locking mechanism is in the form of a crow's foot 812 that is rigidly attached to a valve plug 814 in a first pipe 816. The crow's foot 812 is sized to tightly fit within a slot 822 around a flange 818 on a second pipe 820. When the crow's foot 812 is rotated to a locked position, an aperture 826 within the valve plug 814 is rotated to align with a flow path 824 through the first pipe 816. When the crow's foot 812 is rotated to release the flange 818, the aperture 826 within the valve plug 814 is misaligned with the flow path 824, and the flow path 824 is blocked by the valve plug 814.

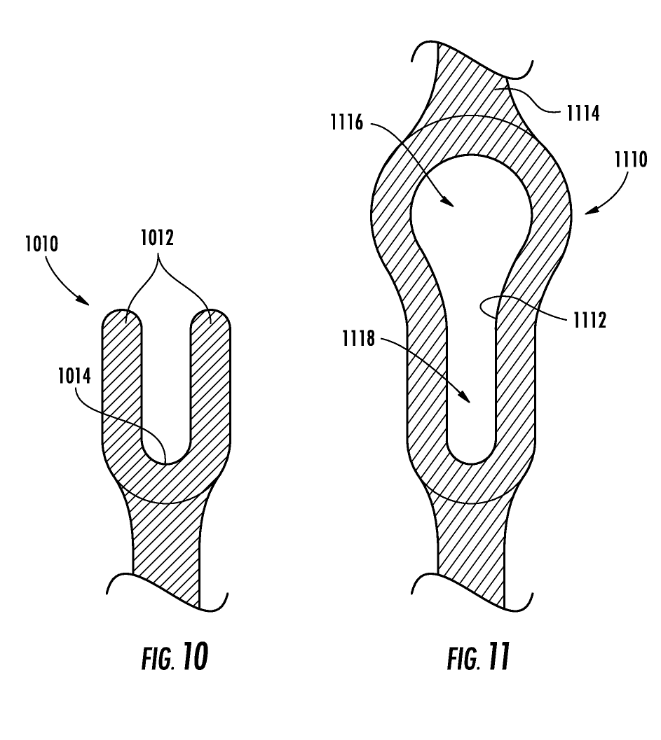

Referring to FIGS. 10-11, locking mechanisms 1010, 1110 are designed to lock onto a flange or protrusion on an instrument, such as a pipe, a hose, or a sprayer (see, e.g., inlet 410 as shown in FIG. 4). According to one embodiment, the locking mechanism 1010 of FIG. 10 includes a fork having prongs 1012 and a seat 1014 (e.g., crow's foot). The prongs 1012 slide into a corresponding slot in the instrument and are locked in place by a flange (see, e.g., slot 822 and flange 818 as shown in FIG. 8). According to another embodiment, the locking mechanism 1110 of FIG. 11 includes an aperture 1112 formed in a wheel 1114. The wheel 1114 may be designed to rotate with rotation of a swivel top of a hose coupler (see, e.g., swiveling top 326 of coupler 312 as shown in FIG. 3). The instrument may be inserted through a wider portion 1116 of the aperture 1112. The wheel 1114 may then be rotated such that a narrower portion 1118 of the aperture 1112 engages a corresponding slot and flange on the instrument, to lock the instrument to the wheel 1114.

The construction and arrangements of the hose coupling system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, configurations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A hose coupling system, comprising:
a housing having an inlet and an outlet, and a flow path therebetween;
a valve plug positioned within the housing along the flow path, wherein the valve plug is rotatable between a closed configuration blocking the flow path and an opened configuration unblocking the flow path; and
a locking mechanism configured to releasably fasten an instrument to the housing, wherein the locking mechanism is adjustable between a locked position and an unlocked position;
wherein the locking mechanism and the valve plug are coupled such that adjusting the locking mechanism to the unlocked position rotates the valve plug to the closed configuration.

2. The hose coupling system of claim 1, wherein adjusting the locking mechanism to the locked position rotates the valve plug to the opened configuration.

3. The hose coupling system of claim 2, wherein the locking mechanism rotates between the locked position and the unlocked position.

4. The hose coupling system of claim 3, wherein the locking mechanism comprises a fork having prongs, wherein the prongs are configured to engage a flange on the instrument.

5. The hose coupling system of claim 3, wherein the valve plug has a circular cross-section.

6. The hose coupling system of claim 5, wherein the valve plug is spherical and has an aperture through which the flow path extends when the valve plug is in the opened configuration.

7. The hose coupling system of claim 5, further comprising a pivot coupled to the valve plug and the locking mechanism.

8. The hose coupling system of claim 7, wherein the locking mechanism is coupled to the pivot via gearing such that rotation of the locking mechanism rotates a first gear, which rotates a second gear that rotates the valve plug.

9. The hose coupling system of claim 8, wherein the gearing is configured to provide a delay between engagement of the locking mechanism and opening of the valve plug.

10. The hose coupling system of claim 8, wherein the gearing is configured to provide a delay between closing of the valve plug and disengagement of the locking mechanism.

11. A hose coupling system, comprising:
a housing having an inlet and an outlet, and a flow path therebetween, wherein the inlet includes a garden hose connector;
a valve plug positioned within the housing along the flow path, wherein the valve plug is rotatable between a closed configuration blocking the flow path and an opened configuration unblocking the flow path; and
a locking mechanism for releasably fastening a sprayer to the housing, the locking mechanism rotatable between a locked position fastening the sprayer to the housing and an unlocked position releasing the sprayer;
wherein rotation of the locking mechanism rotates the valve plug.

12. The hose coupling system of claim 11, wherein the valve plug has a circular cross-section.

13. The hose coupling system of claim 12, wherein the valve plug is spherical and has an aperture through which the flow path extends when the valve plug is in the opened configuration.

14. The hose coupling system of claim 13, wherein the locking mechanism comprises a fork configured to be rotated to engage a flange on the sprayer.

15. The hose coupling system of claim 14, further comprising a control switch, wherein maneuvering the control switch into a first position rotates the locking mechanism into the locked position and the valve plug into the opened configuration, and wherein maneuvering the control switch into a second position rotates the locking mechanism into the unlocked position and the valve plug into the closed configuration.

16. The hose coupling system of claim 15, wherein the control switch is positioned on the housing such that the control switch is configured to be slid with a thumb of a hand that is simultaneously holding the housing, whereby a user may control the locking mechanism and the valve plug with only one hand.

17. A sprayer system for a booster pump for a garden hose, comprising:
a water sprayer, comprising an inlet, an outlet, a handle, and a trigger;
a housing having a garden hose connector and a port for the inlet of the water sprayer;
a locking mechanism that is adjustable between a locked position fastening the inlet to the housing and an unlocked position releasing the inlet from the housing; and
a valve comprising a valve plug positioned within the housing and rotatable between a closed configuration, which blocks water from flowing through the valve, and an opened configuration, which allows water to flow through the valve;
wherein adjustment of the locking mechanism rotates the valve plug.

18. The sprayer system of claim 17, wherein the locking mechanism comprises a fork configured to be rotated to engage a flange on the inlet of the water sprayer.

19. The sprayer system of claim 18, wherein the valve plug has a spherical body and has an aperture for water to pass therethrough when the valve plug is in the opened configuration.

20. The sprayer system of claim 19, wherein the water sprayer is a spray gun and the fork is a crow's foot.
